(19) United States
(12) Patent Application Publication
(10) Pub. No.: US 2004/0237814 A1
(43) Pub. Date: Dec. 2, 2004

(54) Printing stencil and method for preparation thereof

(76) Inventor: Benjamin Caplan, Allison Park, PA (US)

Correspondence Address: CAROTHERS AND CAROTHERS, Suite 500, 445 Fort Pitt Blvd., Pittsburgh, PA, 15219, US

(21) Appl. No.: 10/837,796

(22) Filed: May 3, 2004

Related U.S. Application Data
(60) Provisional application No. 60/473,638, filed on May 29, 2003.

(51) Int. Cl. B41L 13/00

(52) U.S. Cl. 101/127

(57) ABSTRACT

A screen printing stencil is prepared by coating one side of a light transmissive film with a radiation curable material. Then, either the radiation curable material or the opposite side of the film is coated with a print ink receptive surface for receiving and adhering ink from a conventional ink jet printer. The ink receptive surface and the radiation curable material may be one and the same. An ultraviolet block image is printed on the ink receptive surface with a conventional ink jet printer in safe light conditions and the printed side is then exposed to curable radiation for curing areas of the radiation curable material not blocked by the print for providing ink impermeable areas. The noncured areas are washed out with an appropriate solvent and the cured areas are applied to a printing screen mesh, and after drying the cured areas, the film is removed. An ultraviolet light block coating may optionally be provided on the side of the film which is opposite to the side to which the ink print receptive surface is applied.

### BACKGROUND OF THE INVENTION

The present invention relates to the production of stencils for screen printing.

In screen printing a negative of a print design, known as a stencil, is produced on a mesh or screen in those areas of screen where printing is not applied, referred to as the stencil areas, and are covered with a material impervious to the ink to be used for the printing. Typically the screen mesh is a polyamide, polyester or stainless steel mesh, stretched over a wooden or metal frame. The blocked areas will hold back screen printing ink when a squeegee blade or other implement is used to force ink through the mesh onto the surface of the article to be printed.

Many methods are available or have been proposed for the production of screen printing stencils. Stencils can be prepared independently of the screen, by the so-called indirect method, or directly on the screen itself by the so-called direct method.

In the direct method a liquid light sensitive emulsion is coated directly onto the screen mesh to provide a radiation curable coating. After drying, the entire screen is exposed to actinic light, usually ultraviolet (UV) light, through a film positive held in contact with the coated mesh in a vacuum frame. The black portions of the positive do not allow light to penetrate to the emulsion which remains soft and soluble in those areas. In the areas which are exposed to light, the emulsion hardens and becomes insoluble, so that, after washing out with water. the unexposed areas allow ink to pass through on to a substraight surface during a subsequent printing process.

The direct/indirect method involves contacting a film, consisting of a presensitized emulsion on a base support, with a screen mesh by placing the screen on top of the flat film. A squeegee is then forced across the mesh from the opposite side, thus laminating the film to the screen at the same time adhering it to the mesh. After drying the base support is peeled off and the screen is then processed and used in the same way as in the direct method.

In the indirect method a film base is precoated with a presensitized emulsion. The film is exposed to actinic light through a positive held in contact with the coated film. After photo chemical hardening of the exposed emulsion, the unexposed emulsion is washed away. The stencil produced is then mounted on the screen mesh and is used for printing as described above for the direct method.

In the capillary direct method a precoated and presensitized film base is adhered to one surface of the mesh by the capillary action of water applied to the opposite surface of the mesh. After drying, the film is peeled off and the screen then processed and used as described for the direct method.

In addition to the above methods, a hand cut stencil can be used. These are produced by cutting the required stencil design into an emulsion coating on a film base support. The cut areas are removed from the base before the film is applied to the mesh. The emulsion is then softened with a solvent to cause it to adhere to the mesh. After drying, the base is peeled off. The screen is then ready for printing.

A problem generally associated with all of these prior art methods is that there are many steps required to produce the stencil thus making screen production time consuming and labor intensive. A further limitation of these methods are the requirement of a master of film positive, although the image may just as well be negative or reverse, which must be vacuum or pressure contacted to the radiation curable coating.

Yet another method for preparing a printing stencil is described in U.S. Pat. No. 6,539,856 wherein the stencil forming layer is not radiation curable but rather is chemically curable. The stencil forming layer is imaged with an ink jet printer or the like which contains a special cross linking agent which hardens the stencil forming layer to resist washing out with water. The hardened areas remaining after washing out are sufficiently tacky for the film to adhere to the screen mesh by application of pressure. While this method eliminates the need to provide a source of actinic light for exposing the stencil and allows normal lighting to be used throughout the stencil production process, a problem is encountered with this method in the requirement of a special chemical for use in ink jet printers, which further requires an ink jet printer which is dedicated solely for this particular process of producing a stencil.

### SUMMARY OF THE INVENTION

The present invention provides a method for producing or preparing a screen printing stencil independently of the screen wherein a light transmissive film is coated with a radiation curable material, such as a photo sensitive emulsion comprised of a colloid solution containing a photo sensitizer which is soluble in water. Then either this radiation curable coating or the opposite side of the film is coated with an ink jet receptive surface for receiving and adhering print thereon with a digital desktop or wide format ink jet printer.

When applied to the radiation curable coating side of the film, the radiation curable coating and the ink receptive surface may be one and the same. In this instance, the printing is applied directly to the radiation curable coating.

The printing is carried out in safe light conditions, such as red safe light, and optionally, an ultraviolet light block coating may be applied to the side of the film which is opposite to the side to which the ink print receptive surface is applied. This coating prevents UV light from striking the photosensitive emulsion from the top or front side.

The printed side of the film is then exposed to curing radiation (actinic light) for thereby curing areas of the radiation curable material not blocked by the print for providing ink impermeable areas. The noncured areas of the radiation curable material are then washed out with an appropriate solvent, usually water, and the cured areas, which are still tacky, are applied to the printing screen mesh. The cured areas are then dried and the polyester base is removed leaving a screen printing stencil ready for use.

### BRIEF DESCRIPTION OF THE DRAWINGS

Other objects and advantages appear hereinafter in the following description and claims. The accompanying drawings show, for the purpose of exemplification, without limiting the scope of the invention or appended claims, certain practical embodiments of the present invention wherein:

FIG. 1 schematically illustrates a printing screen stencil prepared in accordance with the teachings of the present invention.

FIG. 2 schematically illustrates a second embodiment of a printing screen stencil prepared in accordance with the teachings of the present invention; and

FIG. 3 schematically illustrates a third embodiment of a screen printing stencil prepared in accordance with the teachings of the present invention.

### DETAILED DESCRIPTION OF THE PREFERRED EMBODIMENTS

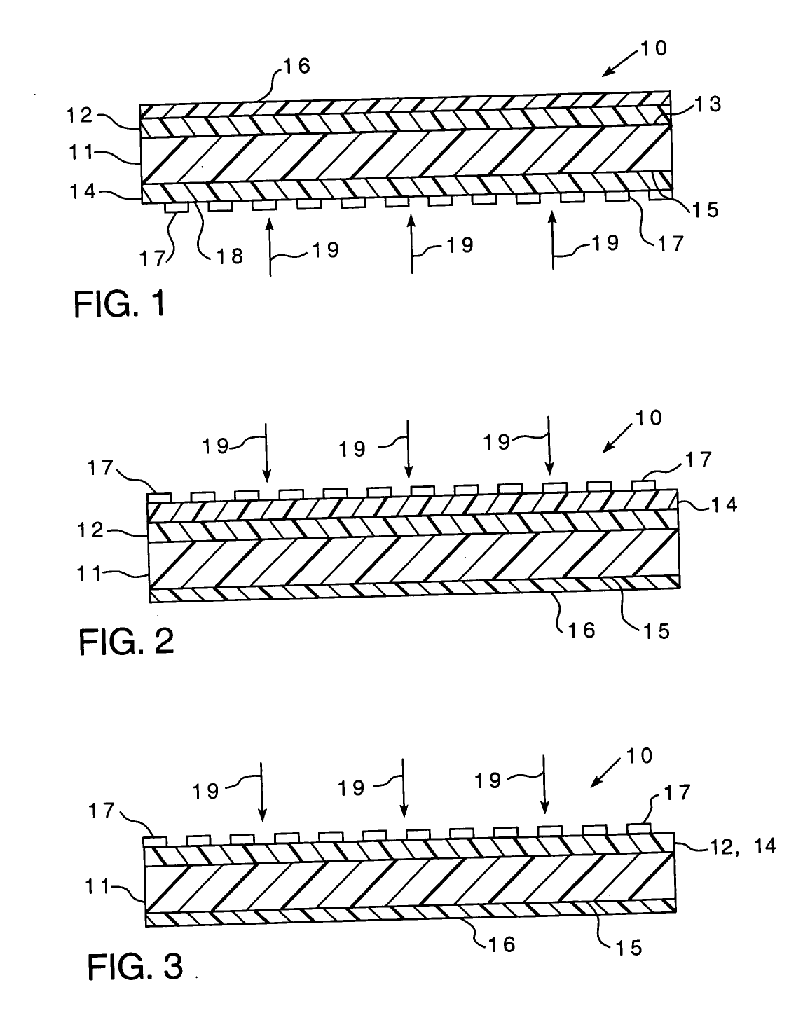

Referring first to FIG. 1, the screen printing stencil 10 of the present invention is comprised of a light transmissive film 111 which is a polymer carrier sheet commonly available in the industry. A radiation curable coating 12 is applied to side 13 of film 11 and a print ink receptive coating 14 is applied to side 15 of radiation curable coating 12. Radiation curable coating 12 is a photosensitive emulsion which is soluble in water or other appropriate solvents such as alcohol. Preferably the radiation curable coating is a water soluble colloid solution containing a photosensitizer such as disclosed in U.S. Pat. Nos. 4,418,138; 4,960,671; 5,061,603; 5,122,442; 5,994,033 and 6,333,137. The print receptive coating 14 is of a type which will readily receive and adhere conventionally available ink jet printing. Such coatings are described, for example, in U.S. Pat. No. 5,380,769 and U.S. Patent Publication No. 2002/0007742. Optionally, ultraviolet light barrier coating 16 is provided over top of the radiation curable coating 12 to prevent ultraviolet light from striking the photosensitive coating 12 from the top side. This UV coating is generally a polymer such as a water soluble colloid solution containing a UV blocker which will wash out along with the noncured areas of the radiation curable coating 12 when the appropriate solvent is applied. This UV light barrier permits handling of the film in minimal light conditions for at least a period of an hour or more without causing curing of the photosensitive emulsion coating 12.

The stencil product thus far described is packaged and distributed to the end user in UV blocking packaging. The end user then removes the composite film from the packaging and prints an image 17 on the print receptive coating 14 with a conventional ink jet printer using conventional inks in red safe or safe light conditions so as not to expose the presensitized coating 12.

Thereafter the printed side 18 of the composite film is exposed to curing radiation 19, such as actinic (UV) light, for thereby curing areas of radiation curable coating 12 not blocked by the print 17 for providing ink impermeable areas. The noncured areas and UV light blocking coating 16 are washed out with the appropriate solvent, generally water. The cured areas, still being tacky, are then applied to a printing screen (not shown) and the cured areas are thereafter dried and the film 11 removed. The resultant screen printing stencil is then ready for use.

FIG. 2 illustrates an alternative embodiment of the composite film of the present invention providing the screen printing stencil 10 of the present invention wherein the print receptive coating 14 is applied to the surface 13 of the radiation curable coating 12 instead of to the opposite side of the film as illustrated in the embodiment of FIG. 1. The ink image 17 is applied to the ink receptive coating 14 in safe light conditions and thereafter exposed to radiation 19 as before. The process previously described with regard to FIG. 1 is then carried out. The print ink receptive coating 14 is also water soluble and washes out with the noncured areas of the photosensitive emulsion 11.

Referring next to FIG. 3, this embodiment is basically identical to the embodiment illustrated in FIG. 2 with the exception that the photosensitive emulsion coating 12 and the print ink receptive coating 14 are one and the same, the emulsion 11 being imparted with qualities whereby the surface thereof will readily accept and adhere ink from a conventional ink jet printer.

I claim:

1. A screen printing stencil comprising a light transmissive film having opposite sides with a radiation curable coating on one of said sides and a print ink receptive coating exteriorly exposed on one of said sides.

2. The screen printing stencil of claim 1 wherein said radiation curable coating is a photosensitive emulsion.

3. The screen printing stencil of claim 2 wherein said radiation curable coating is soluble in water prior to curing.

4. The screen printing stencil of claim 1 including an ink jet printed image on said print ink receptive coating.

5. The screen printing stencil of claim 1 including an ultraviolet light barrier coating on the side of said film which is opposite to said print ink receptive coating.

6. The screen printing stencil of claim 1 wherein said print ink receptive coating is applied to the side of said film opposite to that which said radiation curable coating is applied.

7. The screen printing stencil of claim 6 including an ultraviolet light barrier coating over said radiation curable coating.

8. The screen printing stencil of claim 7 wherein uncured areas of said radiation curable coating and said ultraviolet light barrier coating are both soluble in the same solvent.

9. The screen printing stencil of claim 8 wherein said solvent is water.

10. The screen printing stencil of claim 1 wherein said ink receptive coating is applied over said radiation curable coating.

11. The screen printing stencil of claim 10 including an ultraviolet light barrier coating applied to the side of said film opposite to that which said radiation curable coating is applied.

12. The screen printing stencil of claim 10 wherein uncured areas of said radiation curable coating and said print ink receptive coating are both soluble in the same solvent.

13. The screen printing stencil of claim 12 wherein said solvent is water.

14. The screen printing stencil of claim 1 wherein said ink receptive coating and said radiation curable coating are one and the same.

15. The screen printing stencil of claim 14 including an ultraviolet light barrier coating applied to the side of said film opposite to that which said radiation curable coating is applied.

16. A screen printing stencil comprising a light transmissive film having opposite sides with a radiation curable coating on one of said sides and a print ink image on one of said coating and the side of said film opposite to said coating.

17. The screen printing stencil of claim 16 wherein said image is an ink jet printed image.

18. The screen printing stencil of claim 17 including an exteriorly exposed ultraviolet light barrier coating on the side of said film which his opposite to said printed image.

19. A method for preparation of a screen printing stencil comprising:
coating one side of a light transmissive film with a radiation curable material; and
coating one of the sides of said film with a print ink receptive surface.

20. The method of claim 19, including applying an ultraviolet light block coating on the side of said film which is opposite to the side to which said ink print receptive surface is applied.

21. The method of claim 19, including printing an ultraviolet block image on said print ink receptive surface.

22. The method of claim 21, wherein printing is carried out with an ink jet printer.

23. The method claim 22, wherein printing is carried out in safe light conditions.

24. The method of claim 23, including exposing the printed side of said film to curing radiation for thereby curing areas of said radiation curable material not blocked by said print for providing ink impermeable areas, washing out the noncured areas of said radiation curable material with an appropriate solvent, applying the cured areas to a printing screen, drying the cured areas, and removing the film.

25. The method of claim 20, wherein said ultraviolet light block coating is applied over said radiation curable material and said coating and said material in an uncured state are both water soluble.

26. The method of claim 19, wherein said print ink receptive surface is applied over said radiation curable material and said surface and said material in an uncured state are both water soluble.

27. The method of claim 19, wherein said print ink receptive surface and said radiation curable material are one and the same.

28. A method for the preparation of a screen printing stencil comprising:
coating one side of a light transmissive film with a radiation curable material; and
printing an image on one of said material coating and the side of said film opposite to said coating.

29. The method of claim 28 wherein printing is accomplished with an ink jet printer.

30. The method of claim 29 including applying an exterior ultraviolet light blocking coating on the side of said film which is opposite to said printed image.
